(19) United States
(12) Patent Application Publication
(10) Pub. No.: US 2009/0190026 A1
(43) Pub. Date: Jul. 30, 2009

(54) Pair of Spectacles with Miniature Camera

(76) Inventor: Leo Chen, Zhuhai (CN)

Correspondence Address: G LINK CO LTD, 3550 Bell Road, Minooka, IL, 60447, US

(21) Appl. No.: 12/087,646

(22) PCT Filed: Oct. 11, 2006
(86) PCT No.: PCT/CN2006/002660

§ 371 Date: Mar. 23, 2009

(30) Foreign Application Priority Data
Jan. 11, 2006 (CN) 200620053812.3
Jan. 11, 2006 (CN) 200620053813.8
Mar. 16, 2006 (CN) 200620056605.3

(51) Int. Cl. H04N 5/225; H04N 7/00

(52) U.S. Cl. 348/376; 348/E05.022; 348/552; 348/E07.001

(57) ABSTRACT

A pair of spectacles with miniature camera (122) includes a front frame (1), spectacle lenses (2) and side arms (3). The ends of the front frame (1) are extended backwards to form extending portions (11, 12) with cavities (111, 121), and an opening is formed on the front end of the extending portion (11, 12). The miniature camera (122) facing the opening is arranged on the front end of the cavity (111, 121). A shield (16) is associated to the opening for concealing and protecting the miniature camera (122). A pair of spectacles also includes a connection member (4) having two sides connect to the two spectacle lenses (2) respectively and an end portion have a groove (411) to clip columns provided on the bridge, so that the spectacle lenses (2) can be upturnable.

### BACKGROUND OF THE INVENTION

1. Field of the Invention

The present invention relates to a pair of spectacles, and more particularly to a pair of spectacles with novel functions.

2. Related Art

During special and happy days, people always want to capture and memorize those exciting moments. With the rapid development of high technologies in modern society, video cameras or digital cameras have successively emerged to satisfy people's demands. However, those video cameras and digital cameras are all independent, and have a large volume and a heavy weight, so it is quite inconvenient for people to particularly take along a video camera or a digital camera while going out. On the contrary, spectacles, especially sunglasses, are very popular, but till now no spectacles with camera functions have been made. Therefore, how to properly install a camera device on a pair of spectacles and make the spectacles comfortable to wear, how to make it easy to carry, use, and operate such a pair of spectacles, and how to make the spectacles durable have been problems to be solved for the research and development in this new design.

### SUMMARY OF THE INVENTION

Accordingly, the present invention is directed to a pair of spectacles with a well-protected miniature camera.

The objective of the present invention is achieved through the following technical solutions.

A pair of spectacles with a miniature camera is provided, which includes a front frame, spectacle lenses, and side arms. The pair of spectacles is provided with a miniature camera and a shield. The shield is located in front of the miniature camera.

Two ends of the front frame extend backward to form extending portions with cavities. An opening communicated with the cavity is formed on a front end of the extending portion. The miniature camera facing the opening is mounted in the cavity. The shield is connected to the opening.

The shield is a baffle plate with holes facing the miniature camera.

The extending portions include a left extending portion and a right extending portion. One extending portion is provided with a battery and a data transmission port therein, and the other is provided with the miniature camera, a digital signal processing chip, a flash memory chip, and a circuit board therein.

The circuit board is a folded circuit board assembly, which includes a first circuit board, a second circuit board, a third circuit board, and a fourth circuit board respectively mounted with the miniature camera, the digital signal processing chip, the flash memory chip, and other components. These circuit boards are sequentially connected to one another through a first flexible circuit board, a second flexible circuit board, and a third flexible circuit board.

The first circuit board is folded along the first flexible circuit board toward a rear surface of the second circuit board. The fourth circuit board is folded along the third flexible circuit board toward a front surface of the third circuit board. The first circuit board and the second circuit board are folded by 90 degrees along the second flexible circuit board toward a rear surface of the second circuit board.

The miniature camera is located behind the spectacle lens, and the spectacle lens functions as the shield.

Each side end of the front frame bends backward to form a bent portion, and the bent portion further extends backward to form an extending portion. The miniature camera is disposed in the bent portion, and circuit board component for being connected to the miniature camera is located in the extending portion.

The circuit board component at least includes a circuit board, a control chip, and a flash memory chip. The two side ends of the front frame respectively bend backward to form a left bent portion and a right bent portion. The left and right bent portions respectively extend backward to form a left extending portion and a right extending portion. The miniature camera is located in the right bent portion, and the circuit board component is located in the right extending portion. The pair of spectacles with a miniature camera further includes a data transmission port located in the left bent portion and a battery located in the left extending portion. The front frame is provided with wires for connecting the battery, the data transmission port, the miniature camera, and the circuit board component.

The front frame is movably connected to a connection member. The connection member includes an end portion, two feet formed by extending and splitting the end portion, and two fins formed between the end portion and the feet in a manner of extending outward. The connection member is connected to the two spectacle lenses on two sides.

The fins are provided with pins, the feet are provided with pins, and threaded holes are opened between the fins and the feet. Each spectacle lens is opened with two pinholes respectively engaged with the pins on the fin and the pins on the foot. Each spectacle lens is further opened with a threaded hole engaged with the threaded hole located between the fin and the foot by a screw.

A notch is disposed at the center of the front frame and has a column respectively on a left side wall and a right side wall. An open slot is correspondingly disposed at a rear surface of the end portion of the connection member, so as to clip the columns.

The connection member is in a shape of

[symbol]

The pair of spectacles of the present invention further includes a remote-control receiving/transmitting device for making communications with an external remote-control device. The remote-control receiving/transmitting device includes an encoder/decoder and a receiver/transmitter.

The present invention has the following beneficial efficacies. A connection member in the shape of [symbol] is disposed on the spectacles and includes an end portion, fins, and feet. The sunglass lenses are fixed to the connection member by pins formed on the fins and the feet, and through using screws to sequentially lock the threaded holes opened in the sunglass lenses and that in the connection member. Each set of pins forms a triangle with the screws, so that the sunglass lenses are more stably fixed. An elliptic open slot is opened on the rear surface of the end portion of the connection member, so as to be engaged with elliptic columns disposed on side walls of the notch on the external side at the center of the front frame. The elliptic open slot clips the elliptic columns. The connection member is movably connected to the bridge of the front frame. Therefore, the sunglass lenses are turned upward by revolving the connection member upward, so that the user does not have to take off the spectacles when there is no need to wear the sunglass lenses to block the sun lights. Furthermore, the sunglass lenses can be used for blocking the sun lights by revolving the connection member downward. Thus, the pair of spectacles of the present invention is very convenient in usage. Moreover, as the fins and feet of the connection member share a part of the impacts on the front frame, the sunglass lenses are not easily damaged and become more durable. In addition, the two ends of the front frame are designed to bend and extend backward to form extending portions with cavities, and the camera facing the opening is mounted in the cavity, such that this pair of spectacles can be worn to capture images at any time any where, and it is convenient to carry along. Besides, since the miniature camera faces the front side of the visual field of the user's eyes, the images shot by the camera are substantially the same as those viewed by the user. Furthermore, a shield is connected to the opening in front of the miniature camera, so the miniature camera is located behind the shield and is well concealed. Thus, the pair of spectacles in the present invention looks exactly the same as a pair of ordinary spectacles, and it is difficult to find the miniature camera. The shield is further dustproof, splash-proof, and capable of protecting the miniature camera from being scratched or crashed. Indeed, the sunglass lens itself may serve as a shield for dustproof, avoiding scratches or crash, and providing other protection effects. Furthermore, the camera device adopts a folded circuit board structure to install components such as the miniature camera, digital signal processing chip, and flash memory chip. Therefore, the volume of the camera device is greatly reduced, and accordingly, the size of the extending portion of the front frame is also reduced to save more space. The front frame is also built with a remote-control receiving/transmitting device controlled by an external remote-control device such as a watch or strap. Thus, the pair of spectacles in the present invention can be easily adopted to capture images, and is very convenient to carry along.

### BRIEF DESCRIPTION OF THE DRAWINGS

The present invention will become more fully understood from the detailed description given herein below for illustration only, and thus is not limitative of the present invention, and wherein:

FIG. 1 is a schematic structural view of a pair of spectacles with a miniature camera according to an embodiment of the present invention;

FIG. 2 is a schematic structural view of a circuit board assembly at a completely spread state in a pair of spectacles with a miniature camera according to an embodiment of the present invention;

FIG. 3 is a schematic structural view of a circuit board assembly at a first folded state in a pair of spectacles with a miniature camera according to an embodiment of the present invention;

FIG. 4 is a schematic structural view of a circuit board assembly at a second folded state in a pair of spectacles with a miniature camera according to an embodiment of the present invention;

FIG. 5 is a schematic structural view of a circuit board assembly at a third folded state in a pair of spectacles with a miniature camera according to an embodiment of the present invention;

FIG. 6 is a front structural view of a pair of spectacles with a miniature camera according to an embodiment of the present invention;

FIG. 7 is an exploded structural view of a pair of spectacles with a miniature camera according to an embodiment of the present invention;

FIG. 8 is a schematic structural view of a remote-control watch associated to a pair of spectacles with a miniature camera according to an embodiment of the present invention;

FIG. 9 is a schematic structural view of a remote-control strap associated to a pair of spectacles with a miniature camera according to an embodiment of the present invention;

FIG. 10 is a diagram showing working principles of a pair of spectacles with a miniature camera and an associated remote-control device according to an embodiment of the present invention; and

FIG. 11 is a schematic structural view of another embodiment of the present invention.

The copyrights of the accompanying drawings in the specification and any other equivalent right belongs to the applicant.

### DETAILED DESCRIPTION OF THE INVENTION

Embodiments of the present invention are illustrated below with reference to the accompanying drawings.

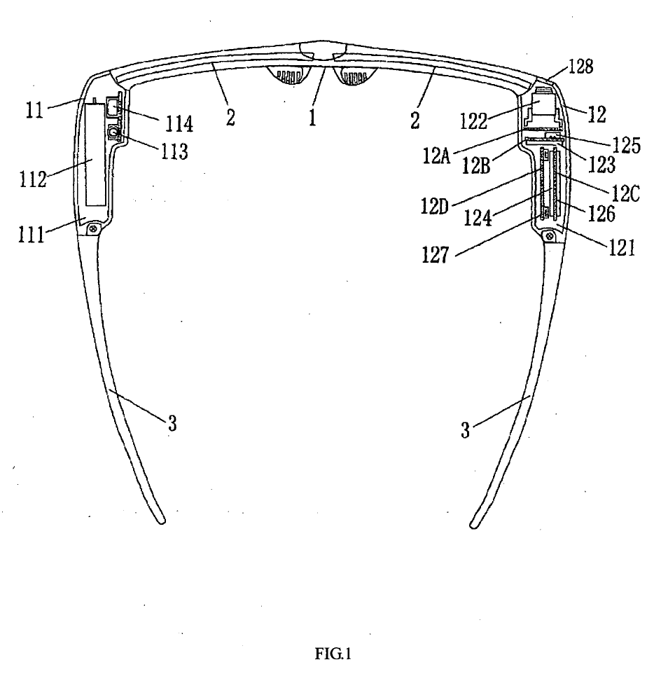

Referring to FIG. 1, the pair of spectacles with a miniature camera provided by the present invention may be a pair of sunglasses, which includes a front frame 1, sunglass lenses 2, and side arms 3. The front frame 1 and the side arms 3 constitute a spectacle frame, and the sunglass lenses 2 are fixed to the front frame 1. The left and right end portions of the front frame 1 bend backward and extend to form a left extending portion 11 and a right extending portion 12. The side arms 3 are respectively hinged to the ends of the two extending portions. The left extending portion 11 and the right extending portion 12 are two mutually-connected cases with cavities 111 and 121. The cavity 111 accommodates a rechargeable battery 112, a port 113 for charging and data transmission, and a TV-out port 114 for connecting to an external display device, which are all mounted on a circuit board in the cavity 111. The cavity 121 accommodates a camera device therein, which is formed by a miniature camera 122, a digital signal processing chip (for example, a CMOS control chip) 123, a flash memory chip 124, and a folded circuit board assembly. An opening 128 is formed on a front end of the right extending portion 12. The miniature camera 122 facing the opening 128 is mounted on a front end of the cavity 121, which faces the front side of the visual field for the user's eyes for capturing images right in front of the user's eyes. Therefore, the images shot by the miniature camera 122 are substantially the same as those viewed by the user. Moreover, the miniature camera 122 is located on an external side of the sunglass lens 2, and directly shoots the images, instead of shooting through the sunglass lens 2, so the captured images are much clearer. The folded circuit board assembly includes a first circuit board 12A, a second circuit board 12B, a third circuit board 12C, and a fourth circuit board 12D. The first circuit board 12A is laterally in parallel with the second circuit board 12B. The third circuit board 12C is longitudinally in parallel with the fourth circuit board 12D, and both the circuit boards are located at a back side of the second circuit board 12B. In addition, the circuit boards are connected with one another via flexible circuit boards. The first circuit board 12A is installed with the miniature camera 122 on a front surface thereof. The second circuit board 12B has a front surface connected to a microphone 125 for recording, and has a rear surface welded with the digital signal processing chip 123. The third circuit board 12C has a right surface welded with the flash memory chip 124. The fourth circuit board 12D has a left surface installed with a remote-control transceiver 126 (including an encoder/decoder and a receiver/transmitter, such as RF240) for making communications with an external remote-control device, and has a right surface installed with control keys 127 for achieving functions such as selecting a shoot mode, starting shooting, stopping shooting, and focusing. Therefore, such a pair of spectacles can be worn to take a video or take pictures at any time any where, which is convenient to carry along. Besides, the camera device is installed in the space formed between the two ends of the front frame and the forehead of the user when the user wears the spectacles, which does not affect the vision of the user. Furthermore, the external sides of two extending portions generally form a right angle just like a pair of ordinary spectacles, and its inner side bulges toward the face of the user. As the inner side of the extending portion bulges at the front end to a larger extent than that of the rear end, a step-like shape is formed to provide a sufficient space for accommodating the camera device. In this manner, the pair of spectacles in the present invention looks exactly the same as a pair of ordinary spectacles, so the camera is well concealed and difficult to be found. In addition, in the spectacles, wires are fixed in a groove opened on an inner side (i.e., the side facing the face of the user) of the front frame 1, and the wires are electrically connected to circuits in the left extending portion 11 and the right extending portion 12.

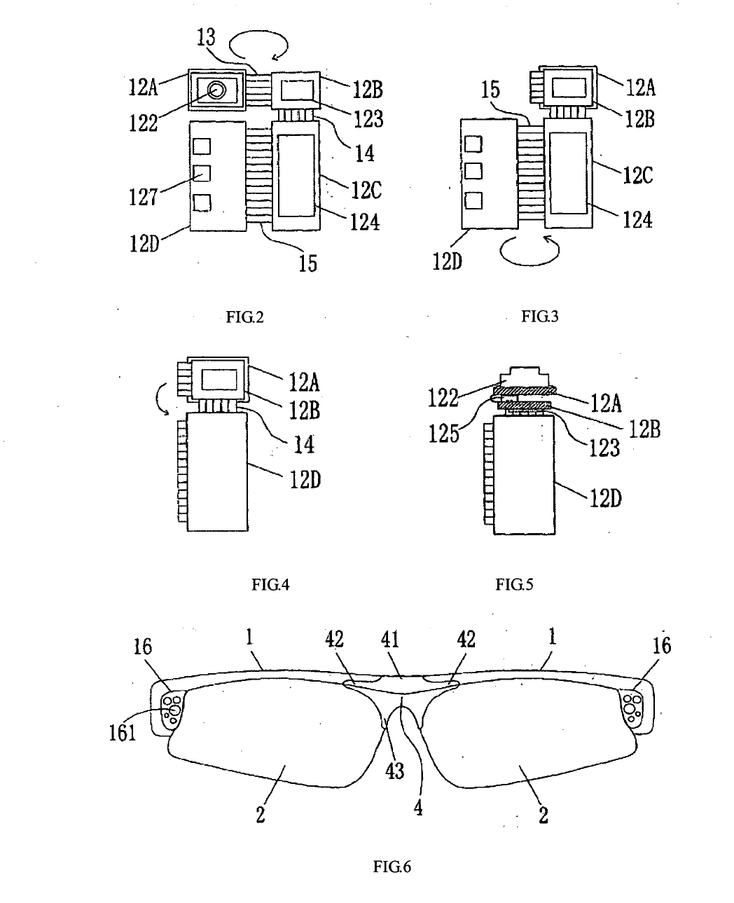

Referring to FIGS. 2, 3, 4, and 5, FIG. 2 is a diagram of the circuit board assembly in a spread state. The first circuit board 12A, the second circuit board 12B, the third circuit board 12C, and the fourth circuit board 12D are sequentially connected via a first flexible circuit board 13, a second flexible circuit board 14, and a third flexible circuit board 15, and are substantially formed into a rectangular shape. The first circuit board 12A is installed with the miniature camera 122 on a front surface thereof. The second circuit board 12B has a front surface installed with the digital signal processing chip 123, and has a rear surface installed with the microphone 125 (as shown in FIG. 5). The third circuit board 12C has a front surface installed with the flash memory chip 124, and has a rear surface installed with the remote-control transceiver 126 (not shown). The fourth circuit board 12D has a front surface installed with the control keys 127. The first circuit board 12A is folded along the first flexible circuit board 13 toward the rear surface of the second circuit board 12B to form a configuration shown in FIG. 3 (at this time, the miniature camera 122 faces downward, and is not shown in FIG. 3). After that, the fourth circuit board 12D is folded along the third flexible circuit board 15 toward the front surface of the third circuit board 12C to form a configuration shown in FIG. 4 (the control keys 127 are located between the third circuit board 12C and the fourth circuit board 12D). Then, the first circuit board 12A and the second circuit board 12B are folded by 90 degrees along the second flexible circuit board 14 toward the rear surface of the second circuit board 12B, so as to form a configuration shown in FIG. 5. Finally, the whole camera device rotates counterclockwise for 90 degrees into the configuration shown in FIG. 1. In this manner, such a folded circuit board structure can greatly reduce the volume of the camera device, and accordingly reduce the volume of the extending portion (or any other place) for accommodating the camera device. Therefore, the pair of spectacles of the present invention saves more space, and is lighter and more comfortable to wear. Besides, the pair of spectacles of the present invention looks similar to a pair of ordinary spectacles, and the camera is thus well concealed.

Referring to FIG. 6, the pair of spectacles of the present invention also has a connection member 4 (the front surface thereof is shown in FIG. 6) connected to an external side of a bridge on the front frame 1. The connection member 4, provided for mounting the sunglass lenses 2, is approximately in the shape of [symbol] and has an end portion 41 connected to the bridge. The connection member 4 extends downward and is split into a left and right feet 43. The end portion 41 and the feet 43 respectively extend outward (i.e., extending toward the left and right sides) to form left and right fins 42 there-between. The opening 128 (not shown) formed on the front side (i.e., the front surface) of the right extending portion 12 further accommodates a shield 16 with several holes. The shield 16 may be a baffle plate (for example, a metal sheet). The miniature camera 122 facing one of the holes 161 is located behind the shield 16, and is thus well concealed and difficult to be found. Moreover, the shield does not affect the camera shooting, but further protects the miniature camera 122 from being scratched or crashed. In addition, several decorative patterns corresponding to the holes 161 are further arranged on the surface of the shield 16 to better conceal the camera. Furthermore, in order to make the spectacles become more elegant by bilateral symmetry in the appearance, the left extending portion 11 is also provided with the same shield 16.

Of course, the shield may also be a lens without holes and capable of protecting the miniature camera 16 from dusts and splash.

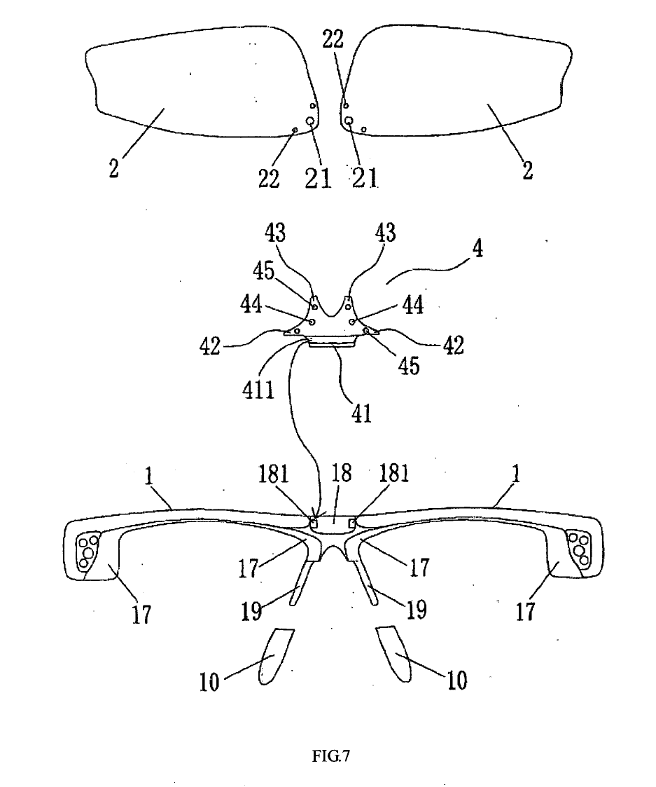

Referring to FIG. 7, in the present invention, the two sides of the front frame 1 are symmetrically designed arc-shaped frames. Each arc-shaped frame has a groove 17 on the surface. A notch 18 is disposed on an external side at the center of the front frame 1 (i.e., on an external side of the bridge). Each side wall is respectively formed on the left and right sides of the notch 18, and is further provided with a column 181. An open slot 411 matching with the columns 181 is formed on the rear surface of the end portion 41 of the connection member 4 (the rear surface after being upturned is shown in FIG. 7). Pins 45 are respectively disposed on the rear surfaces of the fins 42 and the feet 43, and threaded holes 44 are further disposed there-between. Accordingly, threaded holes 21 and pinholes 22 are opened at corresponding positions on inner edges of the sunglass lenses 2. Therefore, during the assembly, the pinholes 22 of the sunglass lenses 2 are first fitted on the pins 45 of the connection member 4. Then, the threaded holes 21 in the sunglass lenses 2 and the threaded holes 44 in the connection member 4 are sequentially locked by screws, so as to fix the sunglass lenses 2 to the connection member 4. Moreover, each group of pins 45 forms a triangle with the screws, so that the sunglass lenses 2 are more stably fixed. Finally, the open slot 411 is aligned with the columns 181, and then forcedly pressed down, so as to clip the columns 181. The connection member 4 is connected to the bridge of the front frame 1. An upper edge of each sunglass lens 2 is located in the groove 17 on the surface of the arc-shaped frame of the front frame 1 (as shown in FIG. 7), so that the sunglass lenses 2 are supported by the front frame 1. Therefore, the sunglass lenses 2 may be turned upward by revolving the connection member 4 upward. In this manner, the user does not have to take off the spectacles when there is no need to wear the sunglass lenses 2 to block the sun lights (for example, entering a room from the outside, or walking into a shade area), and meanwhile, the camera function can still be used. Furthermore, the sunglass lenses 2 can be used for blocking the sun lights by revolving the connection member 4 downward. Thus, the present invention is very convenient in usage, and can be easily disassembled or have the spectacle lenses replaced. Moreover, when the connection member 4 is revolved downward, the fins 42 and the feet 43 thereof share a part of the impacts on the front frame 1, so that the sunglass lenses 2 are not easily damaged and become more durable. In addition, two nose bridges 19 with bumps are further disposed below the bridge of the front frame 1, and can be fixed to the front frame 1 by screws or other means (or can be integrally formed with the front frame 1). The spectacles further have two nose pads 10 respectively fitted on the nose bridges 19 via long holes disposed in the nose pads 10.

Referring to FIG. 8, the remote-control device is a remote-control watch 5, which includes control keys 51 and an indicator bar (or indicator) 52 on an LCD screen of a working display device. The control keys 51 are operated to compile instructions (such as selecting a shoot mode, starting shooting, stopping shooting, and focusing). The indicator bar 52 can display or express relevant instructions in icons. Therefore, the remote-control watch 5 worn on the wrist can be used to take pictures or take a video without being noticed.

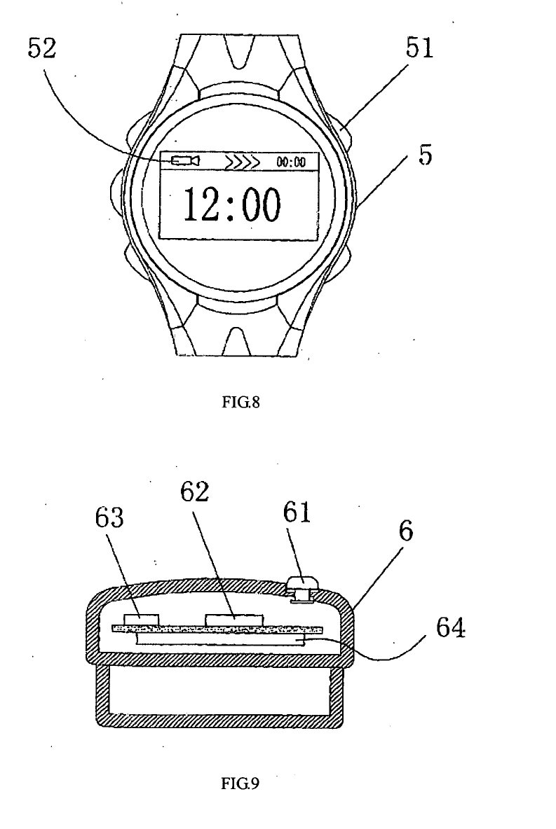

Referring to FIG. 9, the remote-control device may also be a remote-control strap 6 (for example, a watch strap). Similar to the remote-control watch 5, the remote-control strap 6 also includes control keys 61 for compiling instructions (such as selecting a shoot mode, starting shooting, stopping shooting, and focusing), an encoder/decoder 62, a receiver/transmitter 63, and a power source (for example, a button cell) 64. When used together with the spectacles of the present invention, the remote-control strap 6 is used to control the camera device to take pictures or take a video. In addition, the remote-control strap 6 may also be provided with an LCD screen of a working display device or an indicator.

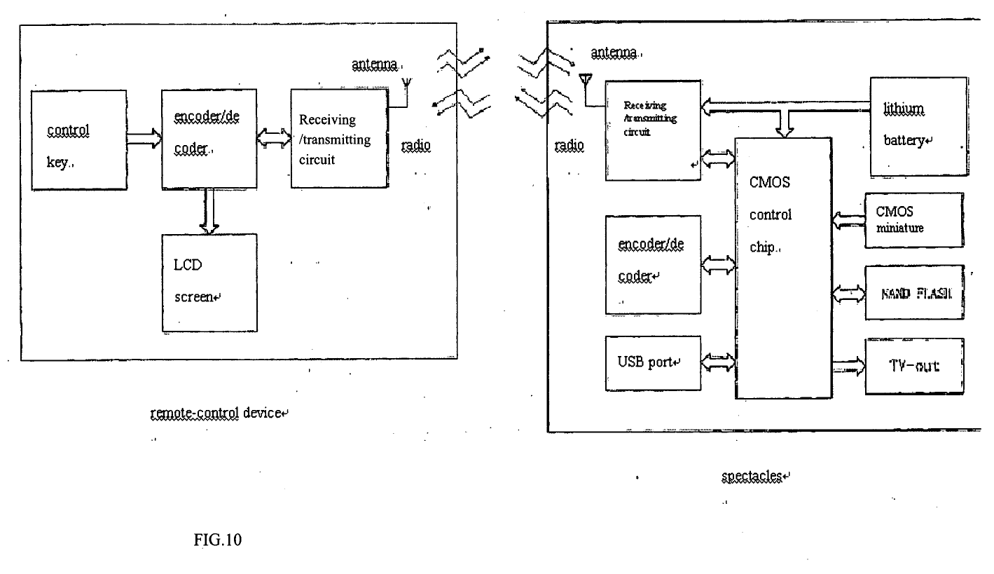

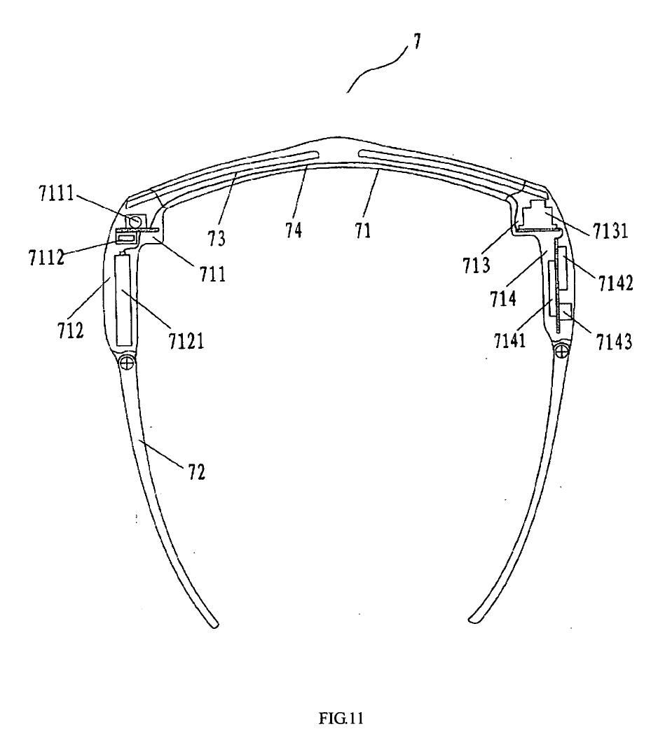

FIG. 10 is a diagram showing working principles of the present invention. When control keys on the external remote-control device are pressed, the encoder/decoder complies the key-press operations into an instruction (such as selecting a shoot mode, starting shooting, stopping shooting, or focusing), and then, the instruction is sent by a receiving/transmitting circuit. The receiving/transmitting circuit (i.e., the remote-control transceiver 126) of the spectacles receives the instruction or a signal from the external remote-control device, and transmits the relevant instruction or signal to the encoder/decoder through the CMOS control chip (i.e., the control chip 123). After being processed, the instruction or signal is returned to the CMOS control chip by the encoder/decoder, and thus, the function of taking a video is realized. Meanwhile, the CMOS control chip sends an instruction or signal to the external remote-control device through the receiving/transmitting circuit, and the processed instruction or signal is displayed on the LCD screen (for example, displayed in the form of an icon on the indicator bar on the LCD screen of the watch). The data captured by the CMOS miniature camera (i.e., the miniature camera 122) is processed by the CMOS control chip and then transmitted to be stored in an NAND FLASH (i.e., the flash memory chip 124). A lithium battery (i.e., the rechargeable battery 112) of the spectacles for supplying a power can be charged and the data transmission can be performed through the USB port 113. Furthermore, the spectacles of the present invention is also provided with a TV-out port 114 for being connected to an external display device (for example, a TV set), so as to play the images stored in the NAND FLASH. In addition, the receiving/transmitting devices installed in the spectacles and the external remote-control device may be radio sets.

Referring to FIG. 11, a pair of spectacles with a miniature camera 7 provided by the present invention includes a front frame 71, side arms 72, and spectacle lenses 73. The side arms 72 are hinged to the front frame 71, and the spectacle lenses 73 are fixed to the front frame 71. The two ends of the front frame 71 bend backward to form a left bent portion 711 and a right bent portion 713. The left bent portion 711 and the right bent portion 713 further extend rightwards to form a left extending portion 712 and a right extending portion 714. The left bent portion 711 has a port 7111 for charging and data transmission and a TV-out port 7112 therein, which are both mounted on a circuit board in the left bent portion 711. The left extending portion 712 has a rechargeable battery 7121 mounted on a circuit board. Furthermore, similarly, the right bent portion 713 has a miniature camera 7131 mounted on a circuit board. The miniature camera 7131 is disposed behind the spectacle lens 73, and faces the front side of the visual field of the user's eyes. The right extending portion 714 has a digital signal processing chip (for example, a CMOS control chip) 7141 and a flash memory chip 7142 therein, which are both mounted on a circuit board. Therefore, such a pair of spectacles can be worn to take a video or take pictures at any time any where, which is convenient to carry along. Besides, the miniature camera does not affect the vision of the user, and the images shot are substantially the same as those viewed by the user. Furthermore, being installed behind the spectacle lens 73, the miniature camera 7131 is well concealed and difficult to be found. In addition, the external sides of the two bent portions generally form a right angle just like a pair of ordinary spectacles, and its inner side bulges outward, such that a step-shaped space is enclosed by the bent portion and the extending portion, so as to provide a sufficient large space for accommodating devices like the miniature camera 7131. As the camera device is installed in the space formed between the two ends of the front frame 71 and the forehead of the user when the user wears the spectacles, the user can wear the spectacles comfortably. The right extending portion 714 is further installed with a remote-control transceiver 7143 (including an encoder/decoder and a receiver/transmitter, such as RF240) for making communications with an external remote-control device. Each bent portion and extending portion are provided with communicated cavities for accommodating the camera device. The camera devices installed on the left and right sides of the front frame 71 are connected via wires 74, and the wires 74 are fixed in a groove opened on an inner side of the beam of the front frame 71. Furthermore, functional keys may be disposed on the inner side of the left and right portions of the front frame 71. In view of the above, the spectacles of the present invention look exactly the same as a pair of ordinary spectacles, so the camera is well concealed. In addition, the pair of spectacles with a miniature camera described in this embodiment has operating principle, functions, and other technical features the same as that in the above embodiment.

What is claimed is:

1. A pair of spectacles with a miniature camera, comprising: a front frame, spectacle lenses, and side arms, wherein the pair of spectacles is provided with a miniature camera and a shield, and the shield is located in front of the miniature camera.

2. The pair of spectacles with a miniature camera according to claim 1, wherein two ends of the front frame extend backward to form extending portions with cavities, and an opening communicated with the cavity is formed on a front end of one extending portion, the miniature camera facing the opening is mounted in the cavity, and the shield is connected to the opening.

3. The pair of spectacles with a miniature camera according to claim 2, wherein the shield is a baffle plate with holes facing the miniature camera.

4. The pair of spectacles with a miniature camera according to claim 3, wherein the extending portions comprise a left extending portion and a right extending portion, one extending portion is provided with a battery and a data transmission port therein, and the other extending portion is provided with the miniature camera, a digital signal processing chip, a flash memory chip, and a circuit board therein.

5. The pair of spectacles with a miniature camera according to claim 4, wherein the circuit board is a folded circuit board assembly comprising a first circuit board, a second circuit board, a third circuit board, and a fourth circuit board respectively installed with the miniature camera, the digital signal processing chip, the flash memory chip, and other components, and the first circuit board, the second circuit board, the third circuit board, and the fourth circuit board are further sequentially connected to one another through a first flexible circuit board, a second flexible circuit board, and a third flexible circuit board.

6. The pair of spectacles with a miniature camera according to claim 5, wherein the first circuit board is folded along the first flexible circuit board toward a rear surface of the second circuit board, the fourth circuit board is folded along the third flexible circuit board toward a front surface of the third circuit board, and the first circuit board and the second circuit board are folded by 90 degrees along the second flexible circuit board toward a rear surface of the second circuit board.

7. The pair of spectacles with a miniature camera according to claim 1, wherein the miniature camera is located behind the spectacle lens, and the spectacle lens functions as the shield.

8. The pair of spectacles with a miniature camera according to claim 7, wherein each side end of the front frame bends backward to form a bent portion, the bent portion further extends backward to form an extending portion, the miniature camera is disposed in the bent portion, and a circuit board component for being connected to the miniature camera is located in the extending portion.

9. The pair of spectacles with a miniature camera according to claim 8, wherein the circuit board component at least comprises a circuit board, a control chip, and a flash memory chip; two side ends of the front frame respectively bend backward to form a left bent portion and a right bent portion, the left and right bent portions respectively extend backward to form a left extending portion and a right extending portion, the miniature camera is located in the right bent portion, and the circuit board component is located in the right extending portion; the pair of spectacles with a miniature camera further comprises a data transmission port located in the left bent portion and a battery located in the left extending portion; and the front frame is further disposed with wires for connecting to the battery, the data transmission port, the miniature camera, and the circuit board component.

10. The pair of spectacles with a miniature camera according to any one of claims 1 to 9, wherein the front frame is movably connected to a connection member, the connection member comprises an end portion, two feet formed by extending and splitting the end portion, and two fins formed between the end portion and the feet in a manner of extending outward, and the connection member is connected to the two spectacle lenses on two sides.

11. The pair of spectacles with a miniature camera according to claim 10, wherein the fins are provided with pins, the feet are provided with pins, and threaded holes are opened between the fins and the feet, each spectacle lens is opened with two pinholes correspondingly engaged with the pins on the fin and the pins on the foot, and each spectacle lens is further opened with a threaded hole correspondingly engaged with the threaded hole located between the fin and the foot by a screw.

12. The pair of spectacles with a miniature camera according to claim 11, wherein a notch is disposed at a center of the front frame and has a column respectively disposed on a left side wall and a right side wall, and an open slot is correspondingly disposed at a back side of the end portion of the connection member, so as to clip the columns.

13. The pair of spectacles with a miniature camera according to claim 10, wherein the connection member is in a shape of

[symbol]

14. The pair of spectacles with a miniature camera according to any one of claims 1 to 9, further comprising: a remote-control receiving/transmitting device for making communications with an external remote-control device, wherein the remote-control receiving/transmitting device is provided with an encoder/decoder and a receiver/transmitter.
